(19) United States
(12) Patent Application Publication
(10) Pub. No.: US 2021/0006583 A1
(43) Pub. Date: Jan. 7, 2021

(54) SYSTEM AND METHOD OF SECURE COMMUNICATION WITH INTERNET OF THINGS DEVICES

(71) Applicant: HighlOT Ltd., Even Yehuda (IL)

(72) Inventors: Igor RYABENKIY, Hertzlia (IL); Igor RABINOVICH, Netanya (IL)

(73) Assignee: HighlOT Ltd., Even Yehuda (IL)

(21) Appl. No.: 16/980,555

(22) PCT Filed: Mar. 12, 2019
(86) PCT No.: PCT/IL2019/050272

§ 371 Date: Sep. 14, 2020

Related U.S. Application Data
(60) Provisional application No. 62/641,453, filed on Mar. 12, 2018.

(51) Int. Cl. H04L 29/06; H04L 29/08; G16Y 30/10; G06N 20/00

(52) U.S. Cl. CPC H04L 63/1433; H04L 67/12; G06N 20/00; H04L 63/1425; H04L 63/0236; G16Y 30/10

(57) ABSTRACT

Systems and methods of vulnerability detection for at least one internet of things (IoT) device in a computer network, including monitoring communication in the computer network to detect at least one IoT device, determining type and behavior of the detected at least one IoT device, checking in at least one vulnerability database in communication with the computer network, for a device profile corresponding to the type of the detected at least one IoT device, and blocking communication between the at least one IoT device and the computer network if the determined behavior of the at least one IoT device violates at least one predetermined rule for the corresponding device profile.

### FIELD OF THE INVENTION

The present invention relates to communication with internet of things (IoT) devices. More particularly, the present invention relates to vulnerability detection for secure communication with IoT devices in a computer network.

### BACKGROUND OF THE INVENTION

In recent years, connected devices (e.g., connected to a communication network such as the internet) have been used in the majority of households, offices and even in cars. However, such devices, and IoT devices in particular, are not monitored for malicious activity and a new device connected to a communication network (e.g., to a Wi-Fi network) may spread a malware to other devices in that network. As smart home systems, with multiple IoT devices, become more popular, they'll provide more potential entry points for hackers to attack these systems.

Moreover, as the number of IoT devices is continuously growing, it becomes harder to monitor and control in a centralized manner all types of IoT devices in use, so there is no way to monitor and/or manage the data transfer to/from these devices. Without a central monitoring system, a solution for the community of IoT device users is needed in order to prevent misuse of this technology.

### SUMMARY

There is thus provided, in accordance with some embodiments of the invention, a method of vulnerability detection for at least one internet of things (IoT) device in a computer network, the method including: monitoring, by at least one monitoring device, communication in the computer network to detect at least one IoT device, determining, by the at least one monitoring device, type and behavior of the detected at least one IoT device, checking, in at least one vulnerability database in communication with the computer network, for a device profile corresponding to the type of the detected at least one IoT device, and blocking communication between the at least one IoT device and the computer network if the determined behavior of the at least one IoT device violates at least one predetermined rule for the corresponding device profile. In some embodiments, the predetermined rule includes a global device profile with basic allowed values for at least one of: allowed protocols, allowed media access control (MAC) addresses, allowed ports, allowed IP range, number of packets in communication, size of packets in communication, and allowed status.

In some embodiments, profiles for the type of the detected at least one IoT device from the computer network are requested by the at least one monitoring device, at least one offer with data corresponding to the type of the detected at least one IoT device is received by the at least one monitoring device, and the offer with the largest amount of profile data is selected by the at least one monitoring device.

In some embodiments, a device profile is updated to the vulnerability database with type and behavior data of the detected at least one IoT device. In some embodiments, valid behavior for the at least one IoT device is determined based on the updated device profile. In some embodiments, a device profile is updated to the vulnerability database with type and behavior data of the detected at least one IoT device, validation checks are requested for the at least one IoT device based on the updated device profile by at least one external monitoring device, and valid behavior is determined for the at least one IoT device if a predetermined amount of external monitoring devices validates the at least one IoT device. In some embodiments, the at least one IoT device is registered, based on the updated device profile, in a data block of a registered IoT device database. In some embodiments, at least one predetermined data packet is sent for each external monitoring device that validates the at least one IoT device.

In some embodiments, wireless communication is monitored in the computer network to capture at least one data packet. In some embodiments, at least one smart contract is implemented to block communication with the at least one IoT device. In some embodiments, the type and behavior of the detected at least one IoT device are determined with at least one machine learning algorithm.

There is thus provided, in accordance with some embodiments of the invention, a vulnerability detection system for at least one internet of things (IoT) device in a computer network, the system including at least one monitoring device, in communication with the computer network and configured to analyze data from the at least one IoT device, and wherein the at least one monitoring device is configured to block communication with at least one IoT device upon determination that the at least one IoT device violates at least one predetermined rule, at least one vulnerability database, configured to communicate with the at least one monitoring device and configured to store profiles of IoT devices, and a server, in communication with the computer network and configured to facilitate communication between the at least one monitoring device and the at least one vulnerability database. In some embodiments, data transferred between the server and the at least one monitoring device includes at least one predetermined rule with a global device profile with basic allowed values for at least one of: type of IoT device, allowed protocols, allowed media access control (MAC) addresses, allowed ports, allowed IP range, number of packets in communication, size of packets in communication, and allowed status.

In some embodiments, the server is configured to request profiles for the type of the detected at least one IoT device, receive at least one offer with data corresponding to the type of the detected at least one IoT device, and select the offer with the largest amount of profile data. In some embodiments, update a device profile to the vulnerability database with type and behavior data of the detected at least one IoT device, and determine valid behavior for the at least one IoT device based on the updated device profile.

In some embodiments, a processor is coupled to the server and configured to carry out processing operations in the vulnerability detection system. In some embodiments, the at least one monitoring device is configured to monitor wireless communication in the computer network to capture at least one data packet. In some embodiments, the server is configured to: update a device profile to the vulnerability database with type and behavior data of the detected at least one IoT device, request validation checks for the at least one IoT device based on the updated device profile by at least one external monitoring device, and determine valid behavior for the at least one IoT device if a predetermined amount of external monitoring devices validates the at least one IoT device. In some embodiments, the server is configured to register the at least one IoT device based on the updated device profile in a data block of a registered IoT device database. In some embodiments, the server is configured to send at least one predetermined data packet for each external monitoring device that validates the at least one IoT device. In some embodiments, at least one smart contract is implemented to block communication with the at least one IoT device.

There is thus provided, in accordance with some embodiments of the invention, a method of vulnerability detection for at least one computerized device in a computer network, the method including: monitoring, by at least one monitoring device, communication in the computer network to detect a type of at least one computerized device, determining, by the at least one monitoring device, behavior of the detected at least one computerized device, checking, in at least one vulnerability database in communication with the computer network, for a device profile corresponding to the type of the detected at least one computerized device, and blocking communication between the at least one computerized device and the computer network if the determined behavior of the at least one computerized device violates at least one predetermined rule for the corresponding device profile. In some embodiments, the at least one computerized is at least one internet of things (IoT) device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an examplary computing device, according to some embodiments of the invention;

FIG. 2 shows a schematic block diagram of a vulnerability detection system, according to some embodiments of the invention;

FIG. 3 shows a block diagram of a profile management system, according to some embodiments of the invention; and

FIG. 4 shows a flowchart for a method of vulnerability detection for at least one internet of things (IoT) device in a computer network, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

According to some embodiments, systems and methods are provided for monitoring of internet of things (IoT) devices in a computer network to detect vulnerabilities. In some embodiments, type and behavior of IoT devices may be determined, and communication with malicious IoT devices may be blocked based on at least one predetermined rule, as further described hereinafter.

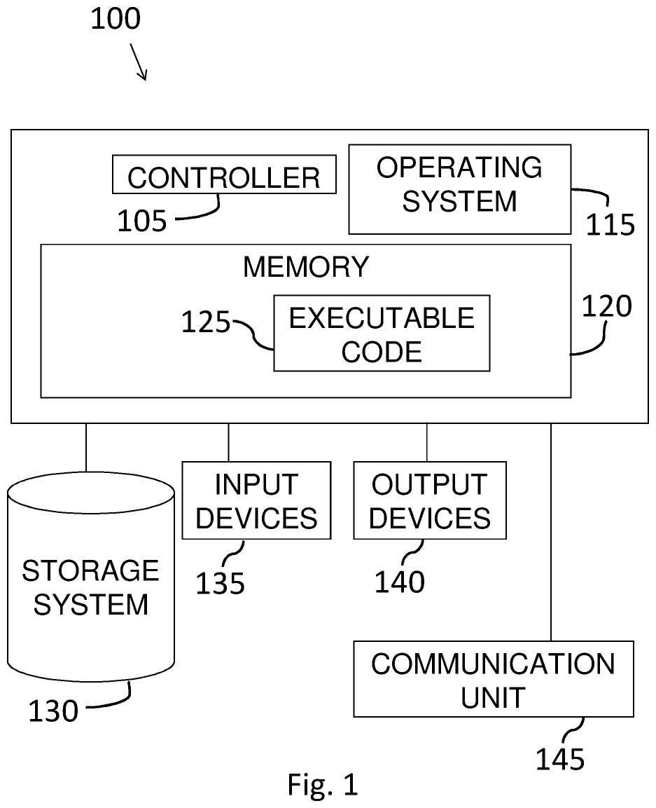

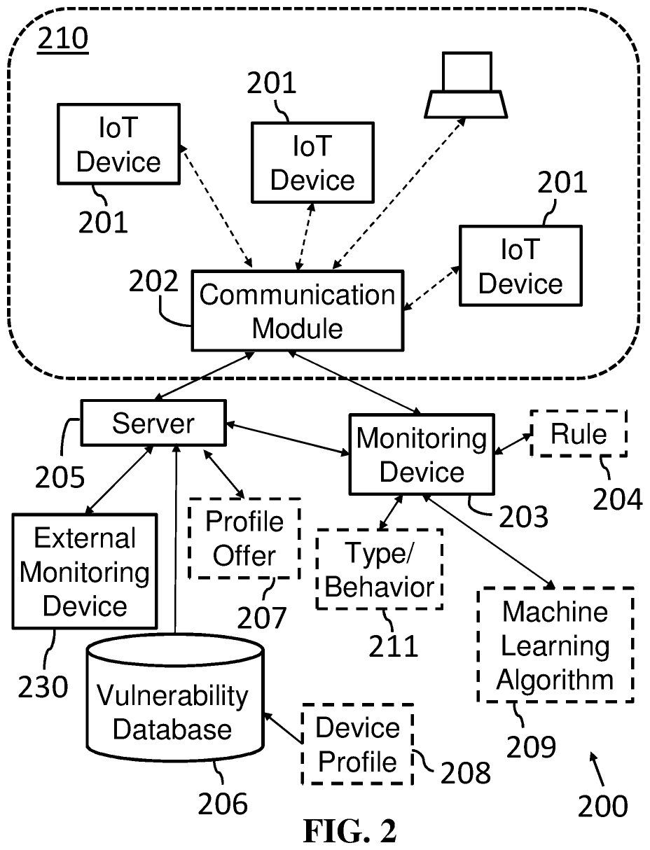

Reference is made to FIG. 1, which is a schematic block diagram of an example computing device, according to some embodiments of the invention. Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard, touchscreen, and/or one or more sensors, such as microphones, light sensors, motion sensors, positioning sensors, image sensor or any other suitable sensor known in the art), and output devices 140 (e.g., a display), a communication unit 145 (e.g., a cellular transmitter or modem, a Bluetooth communication unit, a Wi-Fi communication unit, an Infrared (IR) communication unit, or the like) for communicating with remote devices via a communication network, such as, for example, the Internet. Controller 105 may be configured to execute program code to perform operations described herein. The system described herein may include one or more computing device(s) 100, for example, to act as the various devices or the components shown in FIG. 2. For example, system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a mouse, a keyboard, a touch screen or pad, one or more sensors or any other or additional suitable input device. Any suitable number of input devices 135 may be operatively connected to computing device 100. Output devices 140 may include one or more displays or monitors, speakers, earphones or headphone jacks and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device.

Reference is made to FIG. 2, which is a schematic block diagram of a vulnerability detection system 200 for at least one internet of things (IoT) device 201, according to some embodiments of the invention. In FIG. 2, software elements may be indicated by a dashed line and the direction of arrows may indicate the direction of information flow.

The vulnerability detection system 200 may include a computer network 210 with at least one IoT device 201 coupled to a communication module 202 (e.g., a gateway server communicating via wireless communication, such as Wi-Fi or Bluetooth). The communication module 202 may be also in communication with an external network (e.g., the internet) thereby allowing the at least one IoT device 201 to send data to and/or receive data from external sources. For example, a computer network 210 may be an internal network of a smart home that includes twenty IoT devices 201.

In some embodiments, vulnerability detection system 200 may include at least one monitoring device 203, in communication with the computer network 210 (e.g., via the communication module 202) and configured to analyze data from the at least one IoT device 201. While a single monitoring device 203 is shown in FIG. 2, system 200 may also include multiple monitoring devices 203 to monitor the at least one IoT device 201. Monitoring device 203 may include at least one processor (e.g., such as controller 105 as shown in FIG. 1) to allow analysis and monitoring of data received from the at least one IoT device 201. In some embodiments, monitoring device 203 may be operated as a separate hardware component and/or be installed on another network device (such as an internet service provider (ISP) router, IoT devices hub, etc.). Monitoring device 203 may be for instance used by an insurance company to gather data on all IoT devices 201 within computer network 210 (e.g., within a smart home or a smart car) to create a risk assessment on the possibility of a hacking attack.

In some embodiments, the at least one monitoring device 203 may be configured to block communication with at least one IoT device 201 upon determination that the at least one IoT device 201 violates at least one predetermined rule 204, for instance upon determination that IP address of at least one IoT device 201 exceeds a predetermined range or that an IoT device 201 tries to communicate via a restricted port. For example, communication may be blocked upon determination of deviations in a large group of IoT devices (e.g., dozens of devices) to prevent botnet attacks at real-time (e.g., stop distributed denial of service (DDoS) attacks). In another example, communication may be blocked upon determination of artificial intelligence (AI) powered cyberattacks. In some embodiments, the predetermined rule 204 may include a global device profile with basic allowed values. An IoT device profile may include information regarding the type and characteristics of the IoT device, and/or information regarding behavior of the IoT device (e.g., when the IoT device is active, what ports are used for communication, etc.). In some embodiments, the at least one monitoring device 203 may be configured to monitor wireless (e.g., Wi-Fi, Zigbee, Z-Wave, ultra-light energy digital enhanced cordless communication (ULE DECT), etc.) communication in the computer network 210 to capture at least one data packet.

According to some embodiments, vulnerability detection system 200 may include a server 205 and at least one vulnerability database 206 (e.g., similar to storage system 130 in FIG. 1). The at least one vulnerability database 206 may be configured to communicate with the at least one monitoring device 203 and store profiles of IoT devices 201. The server 205 may be in communication with the computer network 210 (e.g., via the communication module 202) and configured to facilitate communication between the at least one monitoring device 203 and the at least one vulnerability database 206. In some embodiments, vulnerability detection system 200 may include a processor (e.g., such as controller 105 as shown in FIG. 1) coupled to the server 205 and configured to carry out processing operations in the vulnerability detection system 200.

In some embodiments, data transferred between the server 205 and the at least one monitoring device 203 may include at least one predetermined rule 204 on allowed values of: type of IoT device, allowed protocols, allowed media access control (MAC) addresses, allowed ports (e.g., source port and/or destination port), allowed IP range, number of packets in communication, size of packets in communication, and allowed status. For example, at least one predetermined rule 204 may check if the type of IoT device is ‘X’, then allow communication through port ‘Y’, or if communication is not in an allowed protocol, block communication, or if the MAC address is not an allowed MAC address, block communication, and the like.

In some embodiments, monitoring device 203 and/or server 205 may be configured to request profiles (e.g., send a request data packet to computer network 210) for the type of detected at least one IoT device 201, receive at least one profile offer 207 with data corresponding to the type of the detected at least one IoT device 201 and select (e.g., via the monitoring device 203) the offer 207 with the largest amount of profile data.

In some embodiments, monitoring device 203 and/or server 205 may be configured to update a device profile 208 to the vulnerability database 206 with type and/or behavior data 211 of the detected at least one IoT device 201, and determine (e.g., via the monitoring device 204) valid behavior for the at least one IoT device 201 based on the updated device profile 208. In some embodiments, monitoring device 203 and/or server 205 may be configured to request validation checks for the at least one IoT device 201 based on the updated device profile 208 by at least one external monitoring device 230. The monitoring device 203 and/or server 205 may send the updated device profile 208 to an external monitoring device 230, for example a monitoring device similar to monitoring device 203 but without connection to the computer network 210, to validate the updated device profile 208 based on predefined IoT profiles. The monitoring device 203 and/or server 205 may thus determine valid behavior for the at least one IoT device 201 if a predetermined amount (e.g., five) of external monitoring devices 230 validates the at least one IoT device 201.

According to some embodiments, type and/or behavior 211 of the at least one IoT device 201 may be determined by at least one machine learning algorithm 209, for instance using supervised learning on monitored data to learn how IoT devices behave. In some embodiments, monitoring device 203 may use data collected from known IoT devices 201 (with normal or allowed behavior) as input for supervised learning with the at least one machine learning algorithm 209 in order to achieve an algorithm to determine type and/or behavior 211 of newly connected and/or unknown IoT devices 201. For example, the collected data for a particular IoT device 201 may include network activity details with communication carried out from a specific source IP/MAC address and/or to a specific destination IP/MAC address.

The monitoring device 203 may monitor the at least one IoT device 201 to collect data on at least one of: communication time and/or date (e.g., last login), IP/Mac address, version number, traffic throughput frequency, protocols, ports, etc. In some embodiments, monitoring device 203 may monitor the at least one IoT device 201 to detect at least one of: default credential setting, open ports, tunneling, passwords that are easy to find, usage of non-secure protocols (e.g., WPA, WEP) and/or security settings (e.g., WPS), abnormal voice activity from at least one IoT device (e.g., compared to a predefined voice command dataset), abnormal data received from at least one sensor, and/or unregistered commands.

In some embodiments, the monitoring device 203 and/or the server 205 may be configured to register the at least one IoT device 201 based on the updated device profile in a data block of a registered IoT device database, for example register the updated device profile in a dedicated IoT ledger. In some embodiments, vulnerability detection system 200 may be associated with at least one blockchain network, and registration of IoT device profiles may be carried out via a data token exchange and/or with registration on a decentralized data ledger. In some embodiments, the monitoring device 203 and/or the server 205 may be configured to send at least one predetermined data packet (e.g., a data token) for each external monitoring device 203 that validates the at least one IoT device 201.

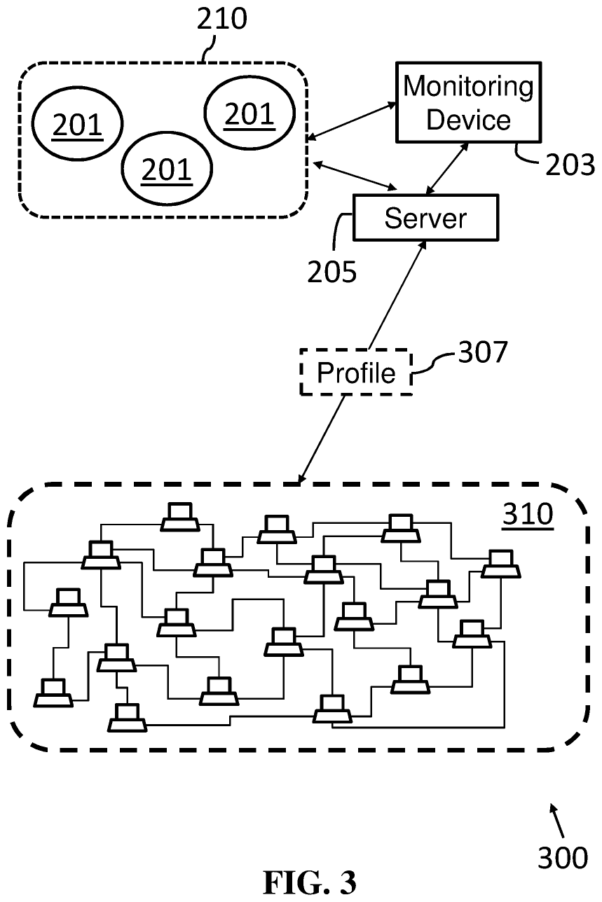

Reference is made to FIG. 3, which shows a block diagram of a profile management system 300, according to some embodiments of the invention. In FIG. 3, software elements may be indicated by a dashed line and the direction of arrows may indicate the direction of information flow. Some elements of the profile management system 300 may be similar to the vulnerability detection system 200, for instance profile management system 300 may include the computer network 210. In some embodiments, monitoring device 203 may determine a new IoT device profile 307 and register the new profile 307 in a dedicated ledger.

The profile management system 300 may include a network with a distributed ledger, such as a blockchain network 310. The blockchain network 310 may include a plurality of distributed nodes configured to manage the IoT device profiles 307. In order to make sure that the IoT device profiles 307 are correct (and not corrupted with vulnerabilities), the blockchain network 310 may be used since an anonymous and/or random user may add registers to the blockchain ledger which in turn may be validated by peer anonymous and/or random users thereby preventing hackers from misusing IoT profiles and/or uploading corrupted profiles.

According to some embodiments, a group of analysts may be registered at profile management system 300, with each such analyst having access to at least one IoT device (e.g., external to vulnerability detection system 200) to be analyzed and provide data to add at least one new profile 307 of IoT devices 201 of vulnerability detection system 200. The analysis of the at least one IoT device may also collect information for at least one machine learning algorithm to automatically generate IoT device profiles. For example, an owner of at least one IoT device may be registered at profile management system 300 and receive (e.g., from server 205) a dedicated analytics tool (e.g., via a mobile application) with instructions and/or tasks to analyze communication from/to the at least one IoT device in order to gather data and create new profiles 307 for unknown IoT devices. Such instructions and/or tasks may also be directed to gather device data such as MAC address, for instance get a task to capture physical image of the device when the address is indicated (e.g., on a sticker at the back of the device). In some embodiments, manufacturers of IoT devices may cooperate with profile management system 300 and reward (e.g., with tokens or the like) analysts that add new profiles 307 as a service to improve security of the IoT devices. In some embodiments, profile verification may be initialized via randomized check of the analysts in order to verify and/or validate each added profile 307.

In some embodiments, several analysts may be defined as trusted analysts, for instance analysts associated with the organization responsible for the vulnerability database 206 (shown in FIG. 2). Data received from these trusted analysts may directly add new trusted profiles 307 to blockchain network 310, or in some embodiments have an increased rank compared to data received from other analysts when a new profile 307 is to be validated prior to registration on the ledger of blockchain network 310. Some profiles 307 may also be verified with proof of authority (POA) by the trusted analysts, for instance defining a quorum of trusted analysts and apply scaling on the defined quorum to optimize the way the profiles 307 are verified by the trusted analysts as well as by other analysts.

In some embodiments, at least one smart contract may be implemented to block communication with the at least one IoT device 201. For example, data requests for IoT device 201 profiles may be sent (e.g., by server 205) to computer network 210 with corresponding response of various IoT device data such that monitoring device 203 may analyze the received IoT device profiles and register each determined profile on a blockchain network associated with the vulnerability detection system 200, whereupon detection of a vulnerability in at least one IoT device 201, the communication therewith may be automatically blocked (e.g., with implementation of a smart contract). In some embodiments, communication with the at least one IoT device 201 may be automatically blocked based on detection of a vulnerability, and for instance implemented with a cloud-based application (e.g., without a blockchain network). In some embodiments, vulnerabilities or security incidents of IoT devices that are determined from new profiles 307 in profile management system 300 may be added to vulnerability database 206, for instance to be purchased by external companies with payment to the corresponding analysts in accordance with at least one smart contract.

Communication with the at least one IoT device 201 may be carried out using at least one smart contract in a blockchain network (e.g., such as the “Ethereum” network) and/or a cloud-based application, for instance to actively block communication with the at least one IoT device 201. In some embodiments, communication with the at least one IoT device 201 may be carried out using a dedicated network for IoT devices (e.g., the “Tangle” network).

According to some embodiments, once a vulnerability is detected in an IoT device 201, for instance with updated profile on vulnerability database 206 and/or registered on a decentralized blockchain network associated with the vulnerability detection system 200, additional communication sessions with that IoT device 201 may be blocked (e.g., by server 205. In some embodiments, all IoT devices having profile similar to the detected vulnerability of IoT device may be also blocked.

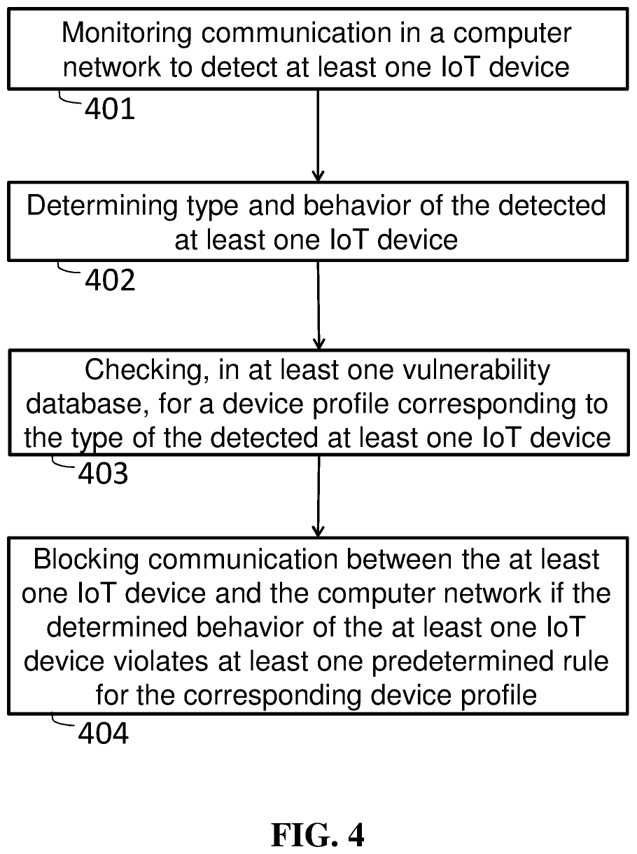

Reference is made to FIG. 4, which shows a flowchart for a method of vulnerability detection for at least one internet of things (IoT) device 201 in a computer network 210, according to some embodiments of the invention.

In some embodiments, the at least one monitoring device 203 may monitor 401 communication in the computer network 210 to detect at least one IoT device 201, and determine 402 type and/or behavior 211 of the detected at least one IoT device 201.

In some embodiments, the at least one monitoring device 203 and/or server 205 may check 403 in at least one vulnerability database 206 in communication with the computer network 210, for a device profile 208 corresponding to the type of the detected at least one IoT device 201. In case that the determined behavior of the at least one IoT device 201 violates at least one predetermined rule 204 for the corresponding device profile 208, the at least one monitoring device 203 and/or server 205 may block 404 communication between the at least one IoT device 201 and the computer network 210. In some embodiments, communication between the at least one IoT device 201 and at least one monitoring device 203 and/or server 205 may be blocked.

In some embodiments, the predetermined rule 204 may include at least one of: allowed protocols, allowed media access control (MAC) addresses, allowed ports, allowed IP range, number of packets in communication, size of packets in communication, and allowed status.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of vulnerability detection for at least one internet of things (IoT) device in a computer network, the method comprising:
monitoring, by at least one monitoring device, communication in the computer network to detect at least one IoT device;
determining, by the at least one monitoring device, type and behavior of the detected at least one IoT device;
checking, in at least one vulnerability database in communication with the computer network, for a device profile corresponding to the type of the detected at least one IoT device; and
blocking communication between the at least one IoT device and the computer network if the determined behavior of the at least one IoT device violates at least one predetermined rule for the corresponding device profile,
wherein the predetermined rule comprises a global device profile with basic allowed values for at least one of: allowed protocols, allowed media access control (MAC) addresses, allowed ports, allowed IP range, number of packets in communication, size of packets in communication, and allowed status.

2. The method of claim 1, further comprising:
requesting, by the at least one monitoring device, profiles for the type of the detected at least one IoT device from the computer network;
receiving, by the at least one monitoring device, at least one offer with data corresponding to the type of the detected at least one IoT device; and
selecting, by the at least one monitoring device, the offer with the largest amount of profile data.

3. The method of claim 1, further comprising:
updating a device profile to the vulnerability database with type and behavior data of the detected at least one IoT device; and
determining valid behavior for the at least one IoT device based on the updated device profile.

4. The method of claim 1, further comprising:
updating a device profile to the vulnerability database with type and behavior data of the detected at least one IoT device;
requesting validation checks for the at least one IoT device based on the updated device profile by at least one external monitoring device; and
determining valid behavior for the at least one IoT device if a predetermined amount of external monitoring devices validates the at least one IoT device.

5. The method of claim 4, further comprising registering the at least one IoT device based on the updated device profile in a data block of a registered IoT device database.

6. The method of claim 5, further comprising sending at least one predetermined data packet for each external monitoring device that validates the at least one IoT device.

7. The method of claim 1, further comprising monitoring wireless communication in the computer network to capture at least one data packet.

8. The method of claim 1, further comprising implementing at least one smart contract to block communication with the at least one IoT device.

9. The method of claim 1, wherein the type and behavior of the detected at least one IoT device are determined with at least one machine learning algorithm.

10. A vulnerability detection system for at least one internet of things (IoT) device in a computer network, the system comprising:
at least one monitoring device, in communication with the computer network and configured to analyze data from the at least one IoT device, and wherein the at least one monitoring device is configured to block communication with at least one IoT device upon determination that the at least one IoT device violates at least one predetermined rule;
at least one vulnerability database, configured to communicate with the at least one monitoring device and configured to store profiles of IoT devices; and
a server, in communication with the computer network and configured to facilitate communication between the at least one monitoring device and the at least one vulnerability database,
wherein data transferred between the server and the at least one monitoring device comprises at least one predetermined rule with a global device profile with basic allowed values for at least one of: type of IoT device, allowed protocols, allowed media access control (MAC) addresses, allowed ports, allowed IP range, number of packets in communication, size of packets in communication, and allowed status.

11. The system of claim 10, wherein the server is configured to:
request profiles for the type of the detected at least one IoT device;
receive at least one offer with data corresponding to the type of the detected at least one IoT device; and
select the offer with the largest amount of profile data.

12. The system of claim 10, wherein the server is configured to:
update a device profile to the vulnerability database with type and behavior data of the detected at least one IoT device; and
determine valid behavior for the at least one IoT device based on the updated device profile.

13. The system of claim 10, further comprising a processor coupled to the server and configured to carry out processing operations in the vulnerability detection system.

14. The system of claim 10, wherein the at least one monitoring device is configured to monitor wireless communication in the computer network to capture at least one data packet.

15. The system of claim 10, wherein the server is configured to:
update a device profile to the vulnerability database with type and behavior data of the detected at least one IoT device;
request validation checks for the at least one IoT device based on the updated device profile by at least one external monitoring device; and
determine valid behavior for the at least one IoT device if a predetermined amount of external monitoring devices validates the at least one IoT device.

16. The system of claim 15, wherein the server is configured to register the at least one IoT device based on the updated device profile in a data block of a registered IoT device database.

17. The system of claim 15, wherein the server is configured to send at least one predetermined data packet for each external monitoring device that validates the at least one IoT device.

18. The system of claim 10, wherein at least one smart contract is implemented to block communication with the at least one IoT device.

19. A method of vulnerability detection for at least one computerized device in a computer network, the method comprising:
monitoring, by at least one monitoring device, communication in the computer network to detect a type of at least one computerized device;
determining, by the at least one monitoring device, behavior of the detected at least one computerized device;
checking, in at least one vulnerability database in communication with the computer network, for a device profile corresponding to the type of the detected at least one computerized device; and
blocking communication between the at least one computerized device and the computer network if the determined behavior of the at least one computerized device violates at least one predetermined rule for the corresponding device profile.

20. The method of claim 19, wherein the at least one computerized is at least one internet of things (IoT) device.
